(19) United States
(12) Patent Application Publication
(10) Pub. No.: US 2024/0230925 A9
(43) Pub. Date: Jul. 11, 2024

(54) SEAMLESS COMPLEX POSITIONING METHOD USING HETEROGENEOUS POSITIONING TECHNIQUES AND POSITIONING CONTROL APPARATUS

(71) Applicant: ELECTRONICS AND TELECOMMUNICATIONS RESEARCH INSTITUTE, Daejeon (KR)

(72) Inventors: Jaejun YOO, Daejeon (KR); Byung Bog LEE, Daejeon (KR); Giyoung LEE, Daejeon (KR)

(21) Appl. No.: 18/487,287

(22) Filed: Oct. 16, 2023

(30) Foreign Application Priority Data
Oct. 19, 2022 (KR) 10-2022-0135264
Feb. 21, 2023 (KR) 10-2023-0022745

(51) Int. Cl. G01S 19/48

(52) U.S. Cl. CPC G01S 19/48

(57) ABSTRACT

Disclosed is a seamless complex positioning method using heterogeneous positioning techniques, the method including: performing, by a positioning control apparatus, satellite signal-based positioning in an area where a satellite signal is received; determining, by the apparatus, whether a first position of a mobile terminal determined using satellite signal-based positioning is close to a shaded area; determining, by the apparatus, a non-satellite signal-based positioning scheme supported in the shaded area when the first position is close to the shaded area; determining, by the apparatus, a second position of the mobile terminal while performing satellite signal-based positioning and positioning according to the non-satellite signal-based positioning scheme simultaneously when the first position is close to the shaded area; and stopping, by the apparatus, satellite signal-based positioning and performing only positioning according to the non-satellite signal-based positioning scheme when the second position is inside the shaded area.

### CROSS REFERENCE TO RELATED APPLICATIONS

This application claims priority to Korean Patent Application No. 10-2022-0135264, filed 19 Oct. 2022, and Korean Patent Application No. 10-2023-0022745, filed 21 Feb. 2023, the entire contents of which are incorporated herein for all purposes by this reference.

### BACKGROUND

### 1. Field of the Invention

The following description relates to indoor and outdoor seamless complex positioning techniques.

This application is supported by the Korea Agency for Infrastructure Technology Advancement (KAIA) grant funded by the Ministry of Land, Infrastructure and Transport (Grant RS-2022-00141819).

### 2. Description of Related Art

Various services that use the position of a mobile terminal, such as a vehicle, and a smartphone, have been introduced. In general, Global Navigation Satellite System (GNSS)-based positioning is used for positioning of a mobile terminal. GNSS-based positioning can only be used in regions where satellites are directly observed. Therefore, GNSS-based positioning is difficult to use in areas (tunnels, and building interiors) where satellite signals are difficult to receive. In the meantime, various types of signal-based positioning such as Wi-Fi and UWB, positioning using the magnetic field of the Earth, or image-based positioning have been studied as indoor positioning.

To achieve seamless (uninterrupted) positioning regardless of time and location, various positioning techniques need to be employed in combination depending on the situation. However, different positioning techniques operate in different systems, so it is difficult to perform real-time integrated interworking. For example, when a control center determines that GNSS-based positioning is not performed and it is intended to use other positioning systems based on Wi-Fi, BLE, and mobile communication (LTE and 5G), position information of a mobile terminal is not obtained while tasks, such as preparing the positioning and scanning to obtain signals, are performed, so it is difficult to perform seamless positioning.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a seamless complex positioning method using heterogeneous positioning techniques, the method including: performing, by a positioning control apparatus, satellite signal-based positioning in an area in which a satellite signal is received; determining, by the positioning control apparatus, whether a first position of a mobile terminal determined using satellite signal-based positioning is close to a particular shaded area; determining, by the positioning control apparatus, a non-satellite signal-based positioning scheme supported in the particular shaded area when the first position is close to the particular shaded area; determining, by the positioning control apparatus, a second position of the mobile terminal while performing satellite signal-based positioning and positioning according to the non-satellite signal-based positioning scheme simultaneously when the first position is close to the particular shaded area; and stopping, by the positioning control apparatus, satellite signal-based positioning and performing only positioning according to the non-satellite signal-based positioning scheme when the second position is inside the particular shaded area.

In another aspect, there is provided a seamless complex positioning control apparatus including: a first positioning module configured to perform satellite signal-based positioning; a second positioning module configured to perform non-satellite signal-based positioning; a seamless complex positioning module configured to (i) determine a first position of a mobile terminal using the first positioning module when the first position of the mobile terminal is in a satellite signal reception area, (ii) determine the first position of the mobile terminal using the second positioning module when the first position of the mobile terminal is in a shaded area, or (iii) determine a second position of the mobile terminal using the first positioning module and the second positioning module simultaneously when the first position of the mobile terminal is in the satellite signal reception area and is close to the shaded area or when the first position of the mobile terminal is in the shaded area and is close to the satellite signal reception area; and a transmission and reception module configured to receive map data from a server, or to query the first position to receive whether the first position is close to the satellite signal reception area or the shaded area.

Other features and aspects will be apparent from the following detailed description, the drawings, and the claims.

### BRIEF DESCRIPTION OF THE DRAWINGS

FIG. 1 shows an example of seamless complex positioning using heterogeneous positioning systems;

FIGS. 2A to 2C show an example of deriving a satellite signal shaded area;

FIG. 3 shows an example of a seamless complex positioning control apparatus;

FIG. 4 shows an example of a flowchart of a seamless complex positioning process; and

FIG. 5 shows an example of a control apparatus for seamless complex positioning.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

A variety of modifications may be made to the present disclosure and there are various embodiments of the present disclosure, particular embodiments of the present disclosure are illustrated in the drawings and will be described in detail. However, the present disclosure is not limited thereto, and the exemplary embodiments can be construed as including all modifications, equivalents, or substitutes in a technical concept and a technical scope of the present disclosure.

Terms “first”, “second”, “A”, “B”, etc. can be used to describe various elements, but the elements are not to be construed as being limited to the terms. The terms are only used to differentiate one element from the other elements. For example, the “first” element may be named the “second” element without departing from the scope of the present disclosure, and the “second” element may also be similarly named the “first” element. The term “and/or” includes a combination of a plurality of items or any one of a plurality of terms.

In the terms used herein, an expression used in the singular encompasses the expression of the plural, unless the context clearly means otherwise. It will be furthermore understood that the terms “comprises”, “comprising”, “includes”, and “including” specify the presence of stated features, numbers, steps, operations, elements, components, or combinations thereof, but do not preclude the presence or addition of one or more other features, numbers, steps, operations, elements, components, or combinations thereof.

Before providing a detailed description of the drawings, it would be clarified that the division of elements in the present disclosure is merely a division according to main functions each element is responsible for. That is, two or more elements, which will be described below, may be combined into one element, or one element may be divided into two or more parts for more detailed functions. In addition to the main functions that each element is responsible for, each of the elements may additionally perform some or all of the functions that the other elements are responsible for. Some of main functions each element is responsible for may be handled and performed by the other elements.

In addition, in performing a method or an operation method, steps constituting the method may occur in an order different from an order described herein unless a specific order is clearly stated in context. In other words, the steps may be performed in the same order as described, may be performed substantially simultaneously, or may be performed in the reverse order.

The present disclosure relates to positioning techniques for a mobile terminal.

The mobile terminal refers to any one of various devices, such as a smartphone, a wearable device, a robot, and a vehicle, which move in a particular area. The mobile terminal may support various heterogeneous positioning techniques.

The heterogeneous positioning techniques may be divided into a satellite signal (GNSS)-based positioning technique and non-satellite signal positioning techniques. The non-satellite signal positioning techniques refer to positioning techniques using signals or information rather than satellite signals. Examples of the non-satellite signal positioning techniques may include a positioning technique using Wi-Fi or BLE signals, a positioning technique using a mobile communication system, a positioning technique using geomagnetism, and an image-based positioning technique. In the description below, details description of individual non-satellite signal positioning techniques will be omitted. The non-satellite signal positioning techniques may use various techniques conventionally developed.

The GNSS-based positioning technique may be used in an area where it is possible to receive satellite signals. Herein, an area where it is possible to receive satellite signals is called a satellite signal area. In addition, an area where it is difficult or impossible to receive satellite signals is called a shaded area.

Uninterrupted positioning in a satellite signal area and a shaded area is called complex positioning or seamless complex positioning.

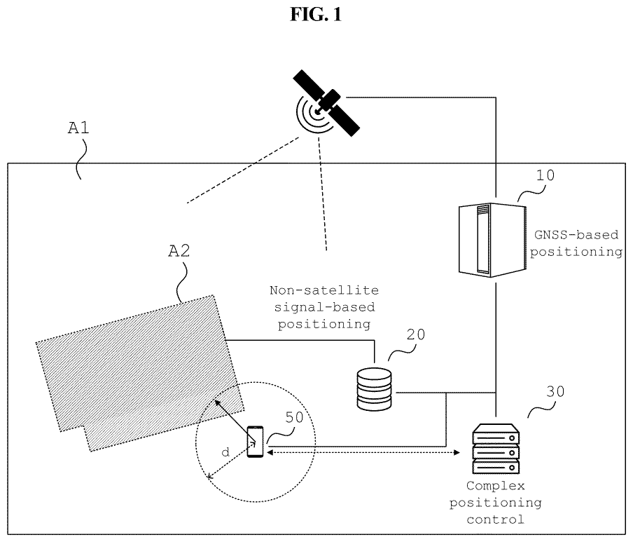

FIG. 1 shows an example of seamless complex positioning using heterogeneous positioning systems.

In FIG. 1, A1 denotes a satellite signal area. A1 is a white area. In FIG. 1, A2 denotes a shaded area. A2 is an area (marked with diagonal lines) within a dotted line.

A GNSS system performs positioning of a mobile terminal 50 in a satellite signal area by using satellite signals. A satellite positioning server 10 uses satellite signals to calculate the position of the mobile terminal 50 in the satellite signal area. A non-satellite signal positioning system performs positioning of the mobile terminal 50 in a shaded area by using non-satellite signals or information. A non-satellite positioning device 20 calculates the position of the mobile terminal 50 in the shaded area.

In FIG. 1, a separate control apparatus 30 may control seamless complex positioning. The control apparatus 30 may control seamless complex positioning by exchanging necessary information with the user terminal 50, the satellite positioning server 10, and the non-satellite positioning device 20. The control apparatus 30 may perform control such that positioning of the mobile terminal 50 is seamlessly performed using the GNSS system or the non-satellite signal positioning system depending on the position of the mobile terminal 50.

The control apparatus 30 may perform control such that while GNSS-based positioning is performed in the satellite signal area, positioning is performed using the non-satellite signal positioning system when the mobile terminal 50 is expected to enter the shaded area. In this case, the control apparatus 30 may perform control such that the non-satellite signal positioning system performs signal pre-scanning and processing or performs the same at a particular point in time.

The control apparatus 30 may determine whether the mobile terminal 50 enters the shaded area from the satellite signal area, on the basis of various criteria. For example, as shown in FIG. 1, when the shaded area exists within a preset radius d of the current position of the mobile terminal 50, the control apparatus 30 may prepare for positioning switching depending on a type of positioning that may be performed in shaded area A2. Alternatively, when the control apparatus 30 is aware of information on the shaded area in advance and the mobile terminal 50 is near an entrance or exit road of the shaded area, the control apparatus 30 may prepare for positioning switching.

Furthermore, the mobile terminal 50 may control seamless complex positioning. In this case, the separate control apparatus 30 may not be needed. The mobile terminal 50 may perform control such that the GNSS system or non-satellite signal positioning system is used depending on the position of the mobile terminal 50 to perform seamless positioning regardless of the position.

The mobile terminal 50 may perform control such that while GNSS-based positioning is performed in the satellite signal area, positioning is performed using the non-satellite signal positioning system when it is expected to enter the shaded area. In this case, the mobile terminal 50 may perform control such that the non-satellite signal positioning system performs signal pre-scanning and processing or performs the same at a particular point in time.

The mobile terminal 50 may determine whether it enters the shaded area from the satellite signal area, on the basis of various criteria. For example, when the shaded area exists within a preset radius d from the current position of the mobile terminal 50, the mobile terminal 50 may prepare for positioning switching depending on a type of positioning that may be performed in shaded area A2. Alternatively, when the mobile terminal 50 is aware of information on the shaded area in advance and the mobile terminal 50 is positioned near an entrance or exit road of the shaded area, the mobile terminal 50 may prepare for positioning switching.

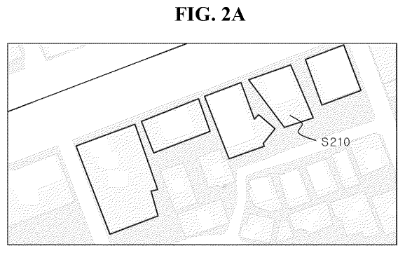

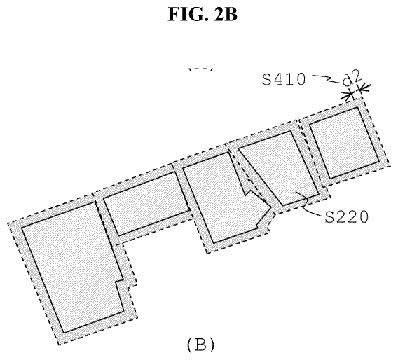

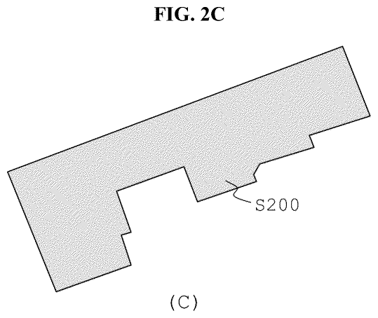

FIGS. 2A to 2C show an example of deriving a satellite signal shaded area. The deriving of the shaded area may be performed before building a system for complex use of heterogeneous positioning systems. The shaded area may be derived in advance using geographic data (map information). The deriving of the shaded area may be performed through a separate computer device.

FIG. 2A shows a part of a downtown area including buildings. FIG. 2A shows the map of the downtown area. In general, the downtown is a region in which satellite signals are received. In the meantime, the interior of a building located in the downtown is a shaded area in which it is difficult to receive satellite signals. The computer device may determine a building area on the basis of the outline S210 of the building based on the downtown map data. The computer device may determine the building area as a shaded area.

In an area between buildings and an area right next to a building, it may be difficult to receive satellite signals well due to the buildings. FIG. 2B shows an example of a building and a building-adjacent area. The computer device may determine a final shaded area by adding a particular additional separation distance d2 S410 to a building outline S220 on a plane based on downtown map data. (i) The separation distance d2 may be a preset fixed distance. (ii) Alternatively, the separation distance d2 may be a particular distance proportional to the height of a building.

The computer device may derive both a building area and a building-adjacent area as a shaded area. FIG. 2C shows a result of deriving a particular shaded area S200 from the map shown in FIG. 2A. The entire shaded area may be calculated by adding a particular separation distance to a boundary line of a building, as shown in FIG. 2B.

Alternatively, the computer device may calculate a shaded area for signals on the basis of orbital information (that is, a position at a point in time when a satellite signal is transmitted) of a known GNSS satellite and the location and height of a building. Through this, the computer device may determine the final shaded area, which is different from the building boundary line.

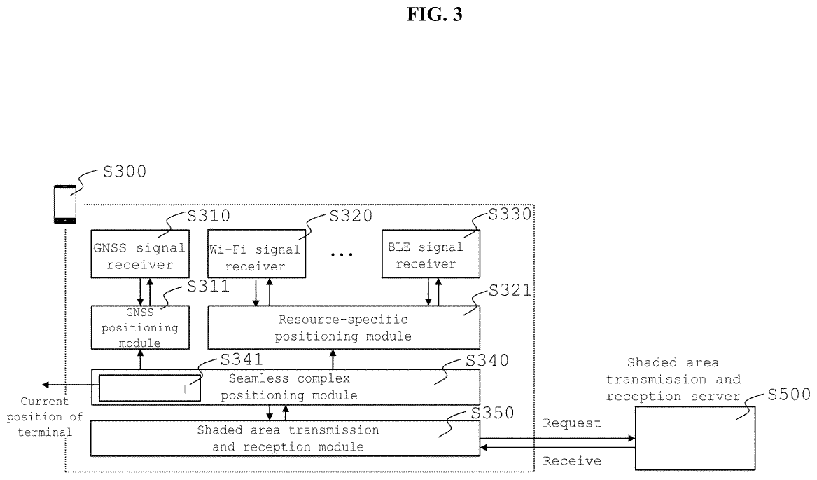

FIG. 3 shows an example of a seamless complex positioning control apparatus S300 using heterogeneous positioning systems. FIG. 3 shows a mobile terminal supporting seamless complex positioning as an example. The module in FIG. 3 may be a software module. In some cases, the module in FIG. 3 may be a module made up of hardware.

A mobile terminal S300 includes a configuration for performing positioning using GNSS signals. The mobile terminal S300 includes: a GNSS signal receiver S310 for receiving GNSS signals in a satellite reception area; and a GNSS positioning module S311 for performing positioning using GNSS signals. The mobile terminal S300 uses the GNSS signal receiver S310 and the GNSS positioning module S311 in the satellite reception area to determine the current position S341 of the mobile terminal S300.

The mobile terminal S300 includes a configuration for determining its position using non-satellite positioning techniques in a shaded area. As described above, there are various types of non-satellite positioning techniques. The mobile terminal S300 may include a configuration for performing positioning using at least one of the various non-satellite positioning techniques. In FIG. 3, the mobile terminal S300 includes a Wi-Fi signal receiver S320, a BLE signal receiver S330, and a resource-specific positioning module S321. According to non-satellite signals or information (resource) available in a shaded area to which the mobile terminal moves or is expected to move, the resource-specific positioning module S321 performs positioning within the shaded area.

As described above, for seamless complex positioning, the mobile terminal S300 needs to switch the current positioning technique for another heterogeneous positioning technique depending on the position or situation of the mobile terminal. A seamless complex positioning module S340 performs positioning switching. The seamless complex positioning module S340 controls various preprocessing and signal scanning for performing heterogeneous positioning techniques. Through this, the seamless complex positioning module S340 may seamlessly determine the current position S341 of the terminal.

The seamless complex positioning module S340 may be configured to (i) determine the position of the mobile terminal using the GNSS positioning module when the current position of the mobile terminal is in a satellite signal reception area; (ii) determine the position of the mobile terminal using the resource-specific positioning module when the current position of the mobile terminal is in a shaded area; or (iii) determine the position of the mobile terminal using the GNSS positioning module and the resource-specific positioning module simultaneously when the current position of the mobile terminal is in the satellite reception area and is close to the shaded area or when the current position of the mobile terminal is in the shaded area and is close to the satellite reception area.

When the previous mobile position is in the satellite reception area, but the position of the mobile terminal of which the seamless complex positioning module S340 performs positioning using the GNSS positioning module and the resource-specific positioning module simultaneously is inside the shaded area, positioning with the GNSS positioning module is stopped and positioning is performed using only the resource-specific positioning module.

When the previous mobile position is in the shaded area, but the position of the mobile terminal of which the seamless complex positioning module S340 performs positioning using the GNSS positioning module and the resource-specific positioning module simultaneously is inside the satellite reception area, positioning with the resource-specific positioning module is stopped and positioning is performed using only the GNSS positioning module.

In the meantime, for switching between the heterogeneous positioning techniques, the mobile terminal S300 may receive map information on a shaded area from a server S500 and use the map information. The information on the shaded area may be viewed and used differently depending on request and reception methods between the mobile terminal S300 and the server S500.

For example, when shaded area information on a particular region (e.g., Daejeon) is downloaded from the server to the terminal, whether the current position of the mobile terminal S300 is close to the shaded area may be determined by the mobile terminal S300 itself through searching.

Alternatively, the mobile terminal S300 may be implemented to periodically receive information on a target region from the server S500 by using a shaded area transmission and reception module S350 separately from the seamless complex positioning module S340.

Alternatively, the mobile terminal S300 may be implemented to transmit the current position S341 of the mobile terminal to the server S500 to check whether a GNSS signal-poor and unavailable region is nearby. In this case, the mobile terminal S300 may receive, from the server, information on the shaded area adjacent to the current position of the mobile terminal and information on the positioning type available in the area.

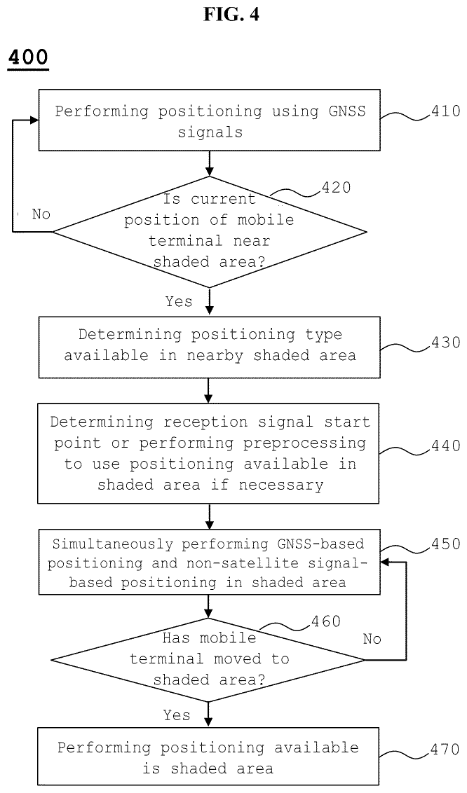

FIG. 4 shows an example of a flowchart of a seamless complex positioning process. FIG. 4 shows a control process for seamless positioning in a situation where a mobile terminal approaches a shaded area. Assuming that the mobile terminal performs a seamless complex positioning process.

The mobile terminal performs positioning using GNSS signals in a satellite reception area in step 410.

The mobile terminal determines whether the current position is near the shaded area on the basis of the position of the mobile terminal in step 420. Periodically, the mobile terminal may determine whether the mobile terminal is positioned near the shaded area. The mobile terminal may determine whether the mobile terminal is close to the shaded area depending on whether a distance between the outline of the shaded area or the entrance or exit point of the shaded area and the current position of the terminal is within a predetermined threshold distance. The mobile terminal may determine its current position using GNSS-based positioning.

When the current position of the mobile terminal is not close to the shaded area, GNSS-based positioning is continuously performed in step 410.

When the current position of the mobile terminal is close to the shaded area, the positioning type available in the nearby shaded area is determined in step 430.

Information on whether the mobile terminal is close to the shaded area or on the positioning type (for example, Wi-Fi, BLE, and LTE/5G-based positioning) available in the shaded area may be determined in various ways as described with reference to FIG. 3. For example, the mobile terminal may determine whether the mobile terminal is close to the shaded area and determine the positioning scheme in the shaded area by using map information downloaded in a batch in advance, information periodically received from the server, or information received by querying the position of the mobile terminal to the server.

For positioning in the shaded area, if necessary, the mobile terminal may perform preprocessing or initialization required to execute the positioning technique, in step 440. Preprocessing may include determining a positioning start point in the shaded area, and signal scanning for positioning.

The mobile terminal simultaneously performs GNSS-based positioning and shaded area-specific positioning in step 450. While simultaneously performing GNSS-based positioning and shaded area-specific positioning, the mobile terminal determines whether the mobile terminal moves to (enter) the shaded area in step 460.

When the mobile terminal enters the shaded area, GNSS-based positioning is not performed and only shaded area-specific positioning is performed in step 470.

In the meantime, when the mobile terminal is close to the shaded area, GNSS-based positioning and shaded area-specific positioning are performed, but any one positioning result may be inaccurate depending on the position of the terminal. In this case, the mobile terminal may continuously monitor each of the results of two types of positionings and may determine whether the positioning results are reliable. For example, when the mobile terminal continues to perform GNSS-based positioning and a positioning result (sudden position change) unreliable considering the current speed is obtained, the GNSS-based positioning result is excluded and only a result of shaded area-specific positioning is used to determine whether the mobile terminal enters the shaded area.

FIG. 4 shows an example of a scenario where a mobile terminal moves from a satellite reception area to a shaded area. Even when the mobile terminal moves from a shaded area to a satellite reception area, seamless complex positioning may be performed in almost the same way. In the latter case, the mobile terminal determines whether the mobile terminal is close to the satellite reception area while performing shaded area-specific positioning. When being close to the satellite reception area, the mobile terminal simultaneously performs GNSS-based positioning and shaded area-specific positioning and determines whether the satellite reception area is entered. When entering the satellite reception area, the mobile terminal uses only GNSS-based positioning.

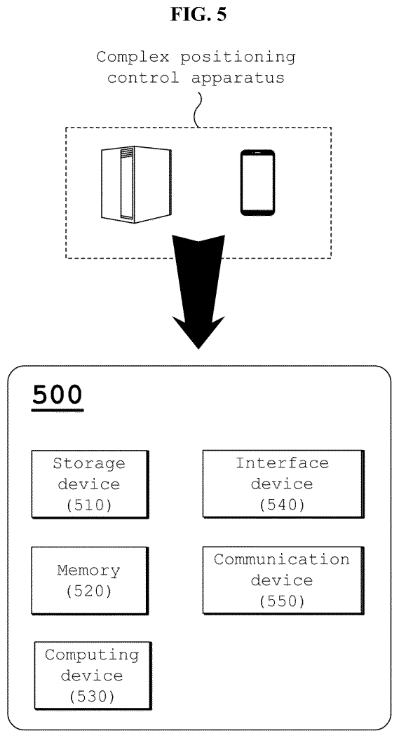

FIG. 5 shows an example of a positioning control apparatus 500 for seamless complex positioning. The positioning control apparatus 500 is a configuration that corresponds to the control apparatus 30 or the mobile terminal 50 shown in FIG. 1.

The positioning control apparatus 500 may include a storage device 510, a memory 520, a computing device 530, an interface device 540, and a communication device 550.

The storage device 510 may store a program for controlling seamless complex positioning. The storage device 510 may store the software modules shown in FIG. 3.

The storage device 510 may store map data including information on a satellite reception area, a shaded area, and positioning techniques supported in the shaded area.

The memory 520 may store data and information generated during a seamless complex positioning process.

The interface device 540 is a device for receiving particular commands and data from the outside. The interface device 540 may receive data and messages for seamless complex positioning from a physically connected input device or an external storage device.

The communication device 550 refers to a configuration for receiving and transmitting particular data over a wired or wireless network. The communication device 550 may receive data and message for seamless complex positioning from an external object.

The communication device 550 may receive satellite signals. Accordingly, the communication device 550 may include a GNSS signal receiver or reception module.

The communication device 550 may receive signals or information (Wi-Fi signals, BLE signals, mobile communication signals, geomagnetic signals, and images) for non-satellite signal positioning. The communication device 550 may include a Wi-Fi signal reception module, a BLE signal reception module, and a mobile communication signal reception module.

The communication device 550 may receive, from the server, entire map data including information on the satellite reception area, the shaded area, and the positioning techniques supported in the shaded area. Alternatively, the communication device 550 may periodically receive map data of an adjacent area from the server.

The communication device 550 may transmit its position to the server, and may receive, from the server, information on whether the current position is in the satellite reception area, the current position is in the shaded area, the current position is in the shaded area close to the satellite reception area, or the current position is in the satellite reception area close to the shaded area.

The communication device 550 may transmit the current position of the mobile terminal to an external object.

In the meantime, the interface device 540 may be a configuration for receiving the data and messages received by the communication device 550, into the positioning control apparatus 500.

The computing device 530 controls a seamless complex positioning process.

The computing device 530 may determine whether the mobile terminal receives satellite signals. The computing device 530 may enable GNSS-based positioning when satellite signals are received.

The computing device 530 may determine whether non-satellite signals are received. When non-satellite signals (Wi-Fi signals, BLE signals, and mobile communication signals) are received, the computing device 530 enables positioning using the signals.

The computing device 530 may enable positioning using signals by which positioning is continuously possible for a particular period of time currently. The computing device 530 may determine its current position using signals by which positioning is continuously possible.

The computing device 530 may determine whether the satellite reception area or the shaded area is close, on the basis of the map data stored in the storage device 510, the map data received from the server, or the current position queried to the server.

A description will be given assuming that the current position of the mobile terminal is in the satellite reception area.

The computing device 530 may use the map data downloaded in advance to determine whether the current position is close to the shaded area. Alternatively, the communication device 550 may receive, from the server, a result of a query based on the current position of the mobile terminal. The computing device 530 may determine whether the current position is close to the shaded area on the basis of the result of the query.

When the current position of the mobile terminal is close to the shaded area, the computing device 530 may determine, from the map data or the query result from the server, a non-satellite signal positioning technique(s) supported by the shaded area.

When the current position of the mobile terminal is close to the shaded area, the computing device 530 may enable GNSS-based positioning and non-satellite signal-based positioning, which is supported by the shaded area, to be simultaneously performed. While GNSS-based positioning and shaded area-specific positioning are simultaneously performed, the computing device 530 determines whether the mobile terminal enters the shaded area.

When the mobile terminal enters the shaded area, the computing device 530 stops GNSS-based positioning and enables only non-satellite signal positioning that the shaded area supports.

A description will be given assuming that the current position of the mobile terminal is in the shaded area.

The computing device 530 may use the map data downloaded in advance to determine whether the current position is close to the satellite reception area. Alternatively, the communication device 550 may receive, from the server, a result of a query based on the current position of the mobile terminal. The computing device 530 may determine whether the current position is close to the satellite reception area on the basis of the result of the query.

When the current position of the mobile terminal is close to the satellite reception area, the computing device 530 may enable GNSS-based positioning and non-satellite signal-based positioning, which is supported by the shaded area, to be simultaneously performed. While GNSS-based positioning and shaded area-specific positioning are simultaneously performed, the computing device 530 determines whether the mobile terminal enters the satellite reception area.

When the mobile terminal enters the satellite reception area, the computing device 530 stops shaded area-specific positioning and enables only GNSS-based positioning.

The computing device 530 may include an arithmetic device, such as a processor, an AP, or a chip in which a program is embedded, for processing data and particular computations.

In addition, the above-described complex positioning method using GNSS-based positioning and non-satellite signal positioning may be realized as a program (or application) including a computer-executable algorithm. The program may be stored and provided in a transitory or non-transitory computer-readable medium.

The non-transitory computer-readable medium refers to a medium that stores data semi-permanently and can be read by a device, rather than a medium, such as a register, a cache, and a memory, which stores data for a short period of time. Specifically, the various applications or programs described above may be stored and provided in the non-transitory computer-readable medium, such as a CD, a DVD, a hard disk, a Blu-ray disk, a USB, a memory card, a read-only memory (ROM), a programmable read-only memory (PROM), an erasable PROM (EPROM), an electrically EPROM (EEPROM), or a flash memory.

The transitory computer-readable medium refers to various RAMs such as static RAM (SRAM), dynamic RAM (DRAM), synchronous DRAM (SDRAM), Double Data Rate SDRAM (DDR SDRAM), Enhanced SDRAM (ESDRAM), synchronous DRAM (SLDRAM), and Direct Rambus RAM (DRRAM).

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A seamless complex positioning method using heterogeneous positioning techniques, the method comprising:
performing, by a positioning control apparatus, satellite signal-based positioning in an area in which a satellite signal is received;
determining, by the positioning control apparatus, whether a first position of a mobile terminal determined using satellite signal-based positioning is close to a particular shaded area;
determining, by the positioning control apparatus, a non-satellite signal-based positioning scheme supported in the particular shaded area when the first position is close to the particular shaded area;
determining, by the positioning control apparatus, a second position of the mobile terminal while performing satellite signal-based positioning and positioning according to the non-satellite signal-based positioning scheme simultaneously when the first position is close to the particular shaded area; and
stopping, by the positioning control apparatus, satellite signal-based positioning and performing only positioning according to the non-satellite signal-based positioning scheme when the second position is inside the particular shaded area.

2. The method of claim 1, wherein the positioning control apparatus is configured to determine whether the first position is close to the particular shaded area and the second position is inside the particular shaded area by using map data downloaded from a server.

3. The method of claim 1, wherein the positioning control apparatus is configured to determine whether the first position is close to the particular shaded area by querying the first position to an external server, and determine whether the second position is inside the particular shaded area by querying the second position to the external server.

4. The method of claim 1, wherein the non-satellite signal-based positioning scheme is at least one selected from a group of a Wi-Fi signal-based positioning scheme, a BLE signal-based positioning scheme, a mobile communication signal-based positioning scheme, and a geomagnetic signal-based positioning scheme.

5. The method of claim 1, wherein the particular shaded area is set by adding a separation distance to an outline of a building extracted from map data, and the separation distance is a preset fixed distance or a distance proportional to a height of the building.

6. The method of claim 1, wherein the particular shaded area is determined according to a position of a satellite transmitting the satellite signal and a position and a height of a building extracted from map data.

7. A seamless complex positioning control apparatus, comprising:
a first positioning module configured to perform satellite signal-based positioning;
a second positioning module configured to perform non-satellite signal-based positioning;
a seamless complex positioning module configured to (i) determine a first position of a mobile terminal using the first positioning module when the first position of the mobile terminal is in a satellite signal reception area, (ii) determine the first position of the mobile terminal using the second positioning module when the first position of the mobile terminal is in a shaded area, or (iii) determine a second position of the mobile terminal using the first positioning module and the second positioning module simultaneously when the first position of the mobile terminal is in the satellite signal reception area and is close to the shaded area or when the first position of the mobile terminal is in the shaded area and is close to the satellite signal reception area; and
a transmission and reception module configured to receive map data from a server, or to query the first position to receive whether the first position is close to the satellite signal reception area or the shaded area.

8. The seamless complex positioning control apparatus of claim 7, wherein the seamless complex positioning module is configured to
stop positioning with the first positioning module and perform positioning only with the second positioning module when the first position is in the satellite reception area and the second position is inside the shaded area, or
stop positioning with the second positioning module and perform positioning only with the first positioning module when the first position is in the shaded area and the second position is inside the satellite reception area.

9. The seamless complex positioning control apparatus of claim 7, wherein the shaded area is set by adding a separation distance to an outline of a building extracted from the map data, and the separation distance is a preset fixed distance or a distance proportional to a height of the building.

10. The seamless complex positioning control apparatus of claim 7, wherein the shaded area is determined according to a position of a satellite transmitting a satellite signal and a position and a height of a building extracted from the map data.
